(19) United States
(12) Patent Application Publication
(10) Pub. No.: US 2002/0162275 A1
(43) Pub. Date: Nov. 7, 2002

(54) Hydroponic apparatus and method

(76) Inventor: Alfred Jack Robinson, Kailua, HI (US)

Correspondence Address: Alfred Jack Robinson, 578 Pamaele Street, Kailua, HI, 96734, US

(21) Appl. No.: 09/849,048

(22) Filed: May 4, 2001

(51) Int. Cl. A01G 31/00

(52) U.S. Cl. 47/62 N

(57) ABSTRACT

There is provided, in a preferred embodiment, a hydroponic apparatus for growing plants within a confined space. Plants rooted in removable containers are placed within a receptacle that rotates on a vertical axis. During hydroponic fertilization a recirculating system delivers and transfers the nutrient solution to and from the receptacle. The plant container in the preferred embodiment allows for removal, replacement, and repositioning of plants within the receptacle. The preferred method increases the photosynthetic service area of the light source in a confined space by arranging a plurality of hydroponic apparatus beneath the light source. The combination of removable containers and rotating receptacles with a plural arrangement of apparatuses prevents algae growth, empowers the grower with plant manageability, and amplifies plant productivity.

### FEDERALLY SPONSORED RESEARCH

Not applicable. cl SEQUENCE LISTING OR PROGRAM

Not applicable.

### BACKGROUND—Field of Invention

This invention relates to hydroponic cultivation of plants photosynthetically serviced by a confined light source. A recirculative system delivers and transfers an aqueous nutrient solution to plants rooted in removable containers.

### BACKGROUND—Prior Art

A hydroponic apparatus provides the necessary nutrients for plant growth via an aqueous nutrient solution. Even though hydroponics eliminates soil for nutrient provision, a plant still requires a rooting medium. Growing beds require large amounts of material and space, and may require expensive pumps and plumbing. Smaller hydroponic apparatuses may use trays, pallets, or platforms instead of large growing beds. These apparatuses typically need supporting structures, such as shelving, tables, benches, or metal framing which further increase the mass of the system.

Plants grown in individual containers empower the grower with instruments for manageability and productivity control. A hydroponic apparatus that grows plants in individual containers requires far fewer resources than those using beds or trays. This means less nutrient solution, less rooting medium, less support structure, less space, and less energy. The capability to reposition, remove, and replace the container when necessary ensures the garden remains at fill capacity. However, previous apparatuses using removable containers have also been large, and expensive.

When growing plants indoors the amount of area photosynthetically serviced by the light source limits plant productivity. The service area of a light source defines the area available for optimum plant growth. In a confined space every plant must be inside the service area for maximum production. This capability may come at a high cost for equipment and a high cost for energy to run this equipment.

U.S. Pat. No. 4,001,968 to Green (1977) discloses a soil irrigation system and method that relate to the irrigation of plants rooted in standard plant containers for cultivation in hothouses and florist shops. Green's hydroponic apparatus requires structure support such as tables and benches, thus reducing the vertical distance available for plant growth. Ceiling height will be of primary importance when using this apparatus within a confined space. The semi-permanence of this apparatus also prohibits it from being easily moved.

Unless used at less than full capacity or used outdoors, plants grown with this hydroponic apparatus will need multiple lamps to provide direct lighting to each container. As the lateral distance from a light source increases the lumens available for photosynthesis decrease rapidly. Only plants within a light source's photosynthetic service area will grow to their fullest.

Green's patent discloses a container with a body filled with water receptive material (rooting medium) and a bottom covered with a water permeable material. The container has no barrier for prohibiting or retarding the growth of algae within its body. Osmotic migration of the nutrient solution from the bottom of the container will continue to the surface of the rooting medium where algae will grow unabated. Addressing this situation will eventually become necessary, resulting in a further expenditure of resources.

U.S. Pat. No. 3,842,535 to Lahr (1973) discloses an apparatus and method for hydroponic cultivation of plants in removable containers. This apparatus requires a support structure that includes leveling blocks, chemical molding foam, or asphalt. Its arrangement of pipes, pumps, and support structure for delivering the nutrient solution to the containers creates a large, heavy, and rigid apparatus. This apparatus would work best for an outdoor garden, and would make a poor choice for indoor growing.

The plant container uses gravel for a rooting medium. Nutrient solution enters the container via the drain holes through pumping action. Although the drain holes are small enough to retain gravel the plant's roots will easily fill the space between the pieces of gravel. Root growth will eventually plug the drain holes, delaying and limiting the rise of nutrient solution within the containers. Lahr's container will encourage nutrient solution overflow and uneven fertilization. Furthermore, this apparatus requires the containers to be set in place and sealed in position. This severely limits the capability of repositioning the container to a position more advantageous for the plant. By its nature of construction and size this apparatus prohibits easy manageability of the plants within a confined space.

Previous hydroponic apparatuses suffered from many disadvantages when considered for use in a confined space.

A peripheral position in a static apparatus requires a plant to be out of the light source's service area. A solution for providing each plant with direct lighting requires a multiple lamp system for maximum plant productivity.

An apparatus' mass and weight limits its appropriateness and suitability for indoor use. Efficiently managing the growing area, both vertically and horizontally, maximizes plant productivity.

Previous hydroponic methods for growing plants in removable containers do not prohibit algae growth and unrestrained root growth. Along with a decrease in plant health and productivity, an increase in maintenance cost would predictably result.

### OBJECTS AND ADVANTAGES

Accordingly, several objects and advantages of the present invention are listed below.

To provide a portable, self-contained hydroponic apparatus with a rotating receptacle for containment of plants rooted in removable containers. The capability for removal, replacement, and repositioning of plants empowers growers with manageability and productivity tools directly resulting in increased productivity.

To provide a powered recirculative mechanism for fertilizing plants at predetermined intervals. The rotating receptacle remains dry between fertilization periods, thus preventing algae's growth within the rotating receptacle. Preventing algae growth reduces maintenance time as well as reducing cost for resources and materials.

To provide a hydroponic apparatus that maximizes the distance from the plant containers to the ceiling. Vertical plant growth optimization occurs because my invention sits directly on the floor and requires no support structure.

To provide plant containers prohibitive to algae growth and unrestrained root growth. Using rock for covering a plant's rooting medium prohibits algae's growth within the container body. A water-permeable plug on the inside bottom of the container constrains root growth and prohibits roots from constricting the flow of nutrient solution. As the rotating receptacle fills with nutrient solution the rooting medium absorbs the nutrient solution as it passes through the water-permeable plug.

To provide a method for growing plants hydroponically that enables direct lighting for all plants, and increases the photosynthetic service area of a confined light source. A plurality of my invention arranged beneath a light source amplifies the photosynthetic service area. This arrangement also enables the rotating receptacle to transport each plant directly into the light source's photosynthetic service area.

To provide a method for growing plants hydroponically whereby nutrient solution aeration occurs during fertilization periods. As the nutrient solution free-falls from a spout into the rotating receptacle air intersperses with the nutrient solution. When the nutrient solution free-falls from the rotating receptacle into a reservoir air again intersperses with the nutrient solution.

To provide a method for growing plants hydroponically whereby aeration of the absorbent material occurs with every fertilization period. Air replaces the nutrient solution in the container's body when the rotating receptacle drains of nutrient solution.

Further objects and advantages are to provide the capability to deliver different nutrient solutions for a variety of plants, with dissimilar nutritional needs, grown under a shared light source. In addition, to provide the capability to address the various nutritional needs of similar plants at different growth stages. Still further objects and advantages will become apparent from a consideration of the ensuing description and drawings.

### SUMMARY

In accordance with the invention herein, a hydroponic apparatus comprising a receptacle, for plant containment, circumvolved on a vertical axis by a rotational drive mechanism with a powered recirculatve mechanism for transferring nutrient solution to and from the receptacle. A method enables removal, replacement, and repositioning of plants within the receptacle. In addition, the method enables direct lighting to each plant and increases the photosynthetic service area of a confined light source.

### DRAWINGS—FIGURES

In the drawings, closely related figures have the same number but different alphabetic suffixes:

FIG. 1 shows a hydroponic apparatus in a perspective view,

FIG. 2 shows a hydroponic apparatus in a frontal view,

FIG. 2B shows a hydroponic apparatus in an exploded view,

FIG. 3 shows a receptacle in perspective view,

FIG. 4 shows a receptacle from a top view,

FIG. 4B shows an enlarged view of the orifice cover,

FIG. 5 shows a sectional view of the receptacle,

FIG. 5B shows an enlarged view of the recessed space in the receptacle,

FIG. 6 shows the reservoir in perspective view,

FIG. 7 shows the reservoir from a top view,

FIG. 8 shows a sectional view of the reservoir,

FIG. 9 shows a sectional view of an empty plant container,

FIG. 9B shows a sectional of a plant container in the preferred embodiment,

FIG. 10 shows a frame affixed with multiple units of the receptacle.

### REFERENCE NUMERALS

20 bottom of rotating receptacle

21receptacle containment wall

22 receptacle drainage orifice

23 quadri-hedral member

24 drainage channel

25 orifice cover

26 threaded recessed space in receptacle bottom

27 shaft arbor

28 nutrient solution reservoir bottom

29 reservoir outer-containment wall

30 aperture in center of reservoir bottom

31 reservoir inner-containment wall

32 access opening in inner-containment wall

33 bearing plate

34 hole in bearing plate

35 turn-table bearing

36 motor

37 screws for mounting motor to bearing plate

38 spacers

39 spout

40 pump

41 flexible tubing

42 plant container bottom

43 plant container containment wall

44 plant container drain hole

45 water permeable plug

46 plant container body

47 absorbent material

48 non-absorbent material

49 frame

### DETAILED DESCRIPTION—Preferred Embodiment

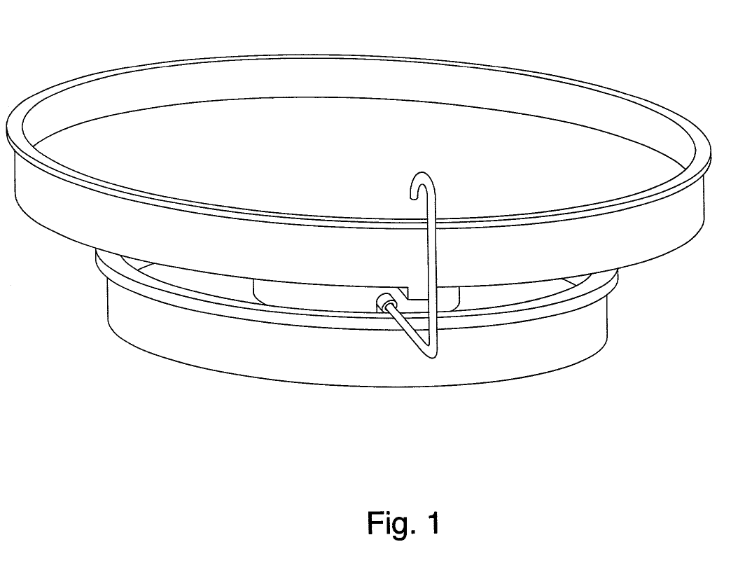

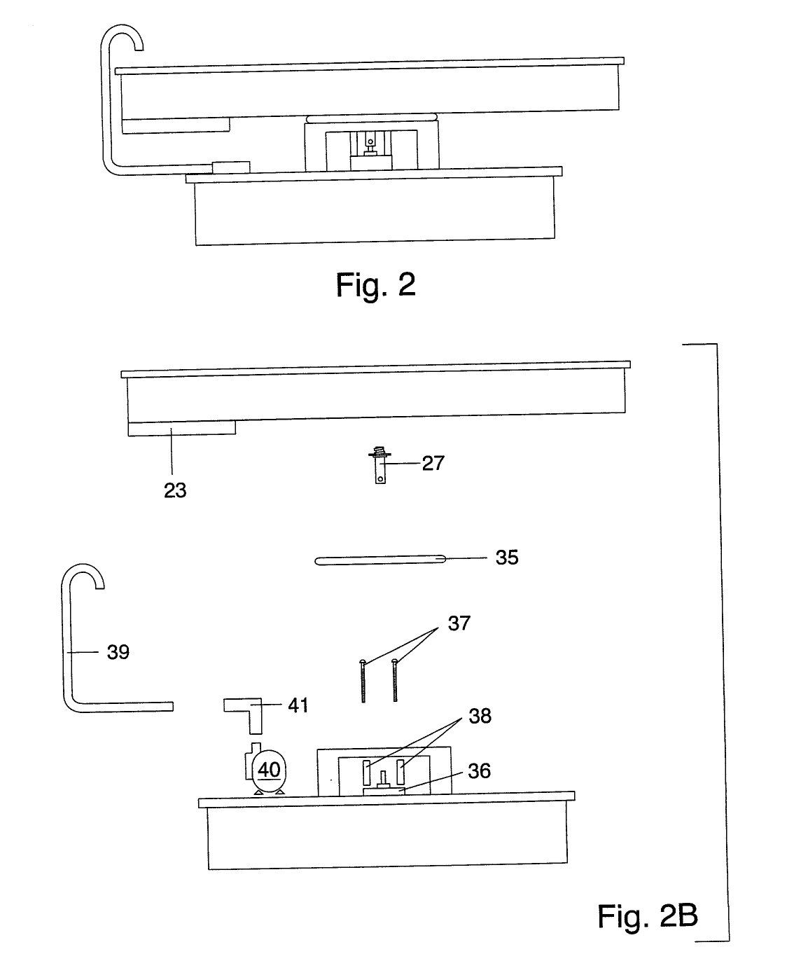

A rotating receptacle for retaining plants rooted in removable containers constitutes the primary feature of my hydroponic apparatus. FIG. 1 shows a preferred embodiment for the present invention. FIG. 2 and FIG. 2B show a frontal view and a corresponding exploded view.

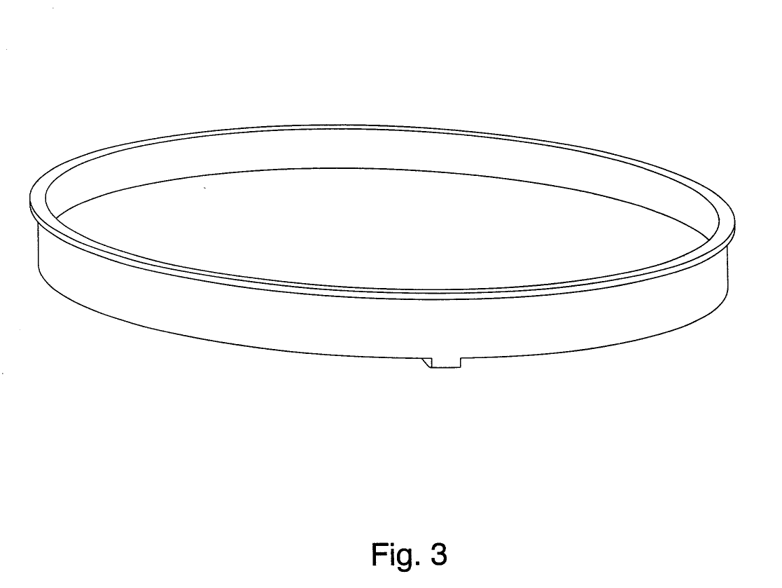

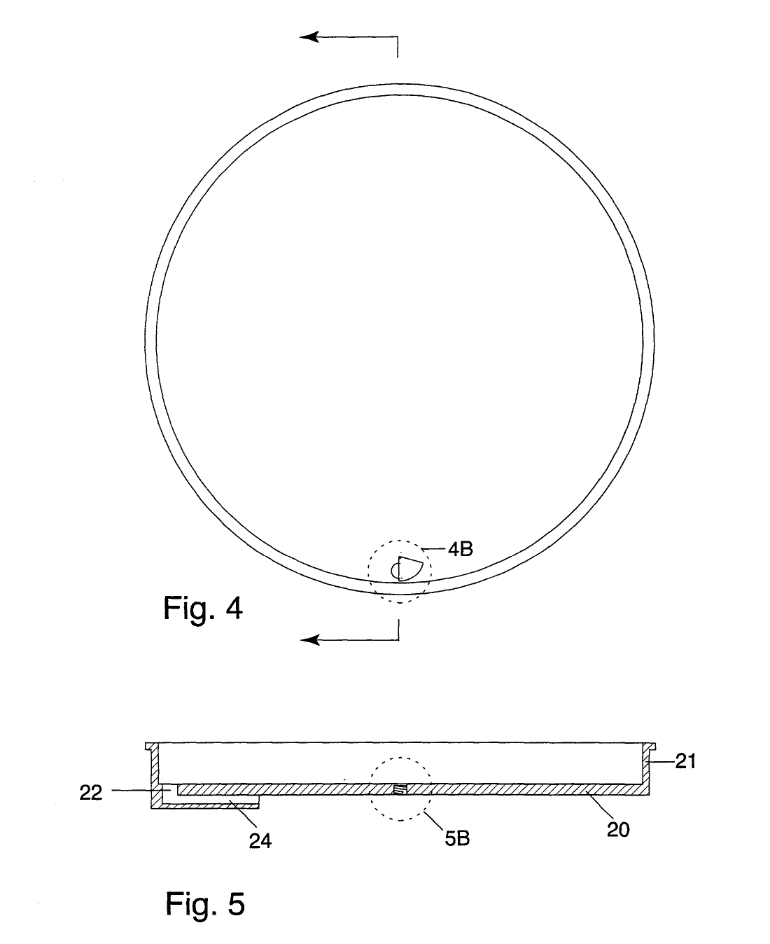

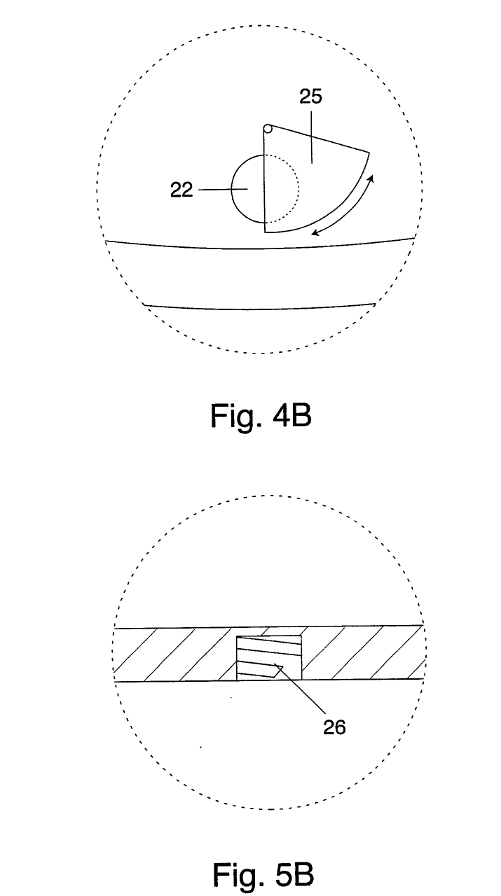

The receptacle shown in FIG. 3 (perspective), FIG. 4 (top view), and FIG. 5 sectional view) will be of circumferential configuration comprising a planar rigid bottom 20 and an upstanding containment wall 21. Containment wall 21 encircles perimeter of and contiguously conjoins bottom 20. Bottom 20 has a diameter determined from a percentage of area the light source photosynthetically services. Containment wall 21 will not be taller than the height of any plant container placed in the receptacle. Containment wall 21 will be taller than the highest point of any drain opening of any plant container placed in the receptacle.

As seen in FIG. 4 and FIG. 5, the nutrient solution, once transferred to the receptacle, drains out through orifice 22. Quadrihedral member 23 creates a channel 24 for transferring the nutrient solution to a reservoir. Member 23, FIG. 2B, contiguously conjoins the underside of bottom 20 directly beneath orifice 22. Cover 25, FIG. 4 and FIG. 4B, fastens to the topside surface of bottom 20 (fastener not shown), and in combination with orifice 22 comprises a valve for controlling the volume of nutrient solution draining from the receptacle. The underside of bottom 20, FIG. 5 and FIG. 5B, contains a threaded recessed space 26 that accepts shaft arbor 27, FIG. 2B.

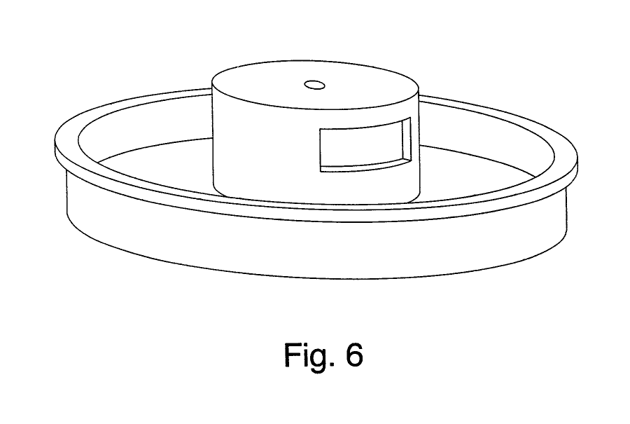

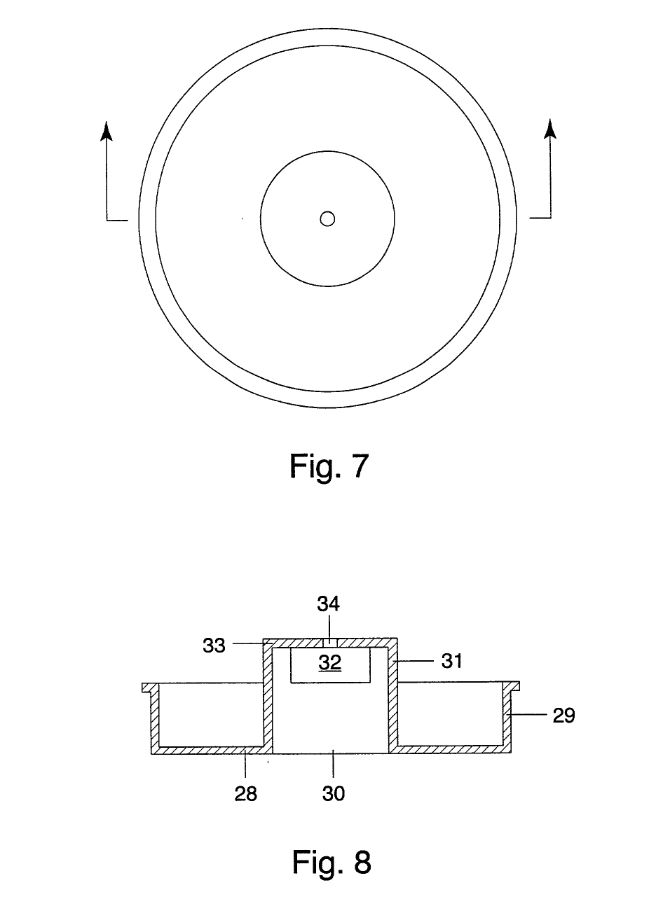

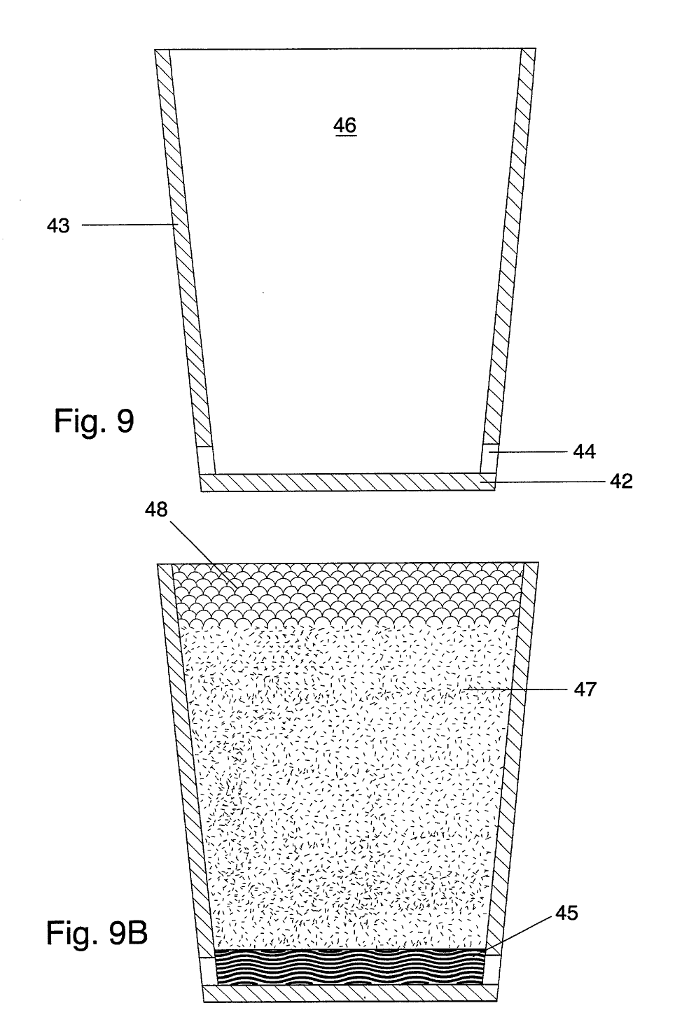

The nutrient solution reservoir, FIG. 6 (perspective view), FIG. 8 (top view), and FIG. 9 (sectional view) has a rigid planar bottom 28 circumferential in configuration with an aperture 30 in its center. An upstanding outer-containment wall 29 encircles and contiguously conjoins the perimeter of bottom 28. An upstanding inner-containment wall 31 encircles aperture 30 and contiguously conjoins bottom 28. An opening 32 within inner-containment wall 31 provides accessibility. The reservoir volume shall not exceed the volume of the receptacle.

Bearing plate 33 contiguously conjoins perpendicularly with the horizontal surface of inner-containment wall 31. Bearing plate 33 will be of circumferential planar design with a hole 34 in the center. Shaft arbor 27 passes through hole 34 when the receptacle interfaces the reservoir via bearing plate 33 and a turn-table bearing 35. Bearing 35 fastens to bearing plate 33 (fasteners not shown). Bearing 35 will be of a predetermined size compatible for performing its task. With the apparatus at fill capacity, the reservoir will be capable, through predetermined size and strength parameters, of supporting the entire structure.

Mounted to the under surface of bearing plate 33, motor 36, FIG. 2B, attaches with a plurality of a screw 37 and a spacer 38. Opening 32 and inner-containment wall 31 shall be of predetermined dimensions for providing easy access for connecting shaft arbor 27 to motor 36. When empowered motor 36 circumvolves the receptacle around a vertical axis.

A pump 40 transfers the nutrient solution from the reservoir into the receptacle via spout 39. Pump 40 sits unattached on the top surface of bottom 28. The outlet port of pump 40 interfaces spout 39 via flexible tubing 41. Spout 39 and the outlet port of pump 40 shall have the same inside diameter. Spout 39 clasps (clasp not shown) to the outer-containment wall of the reservoir.

Using manufacturing techniques of injection molding, casting, thermoforming, and cold molding; the receptacle, the reservoir, and spout 39 will be made of Acrylon Butadiene Styrene in the preferred embodiment.

Although Acrylon Butadiene Styrene shall be the preferred material for manufacture of my invention; other thermoplastics such as polyethylene, polypropylene, polyvinyl chloride, polymethyl methacrylate, or polycarbonate may be used. In addition; a variety of thermoset plastics, metals, fiberglass, wood, ceramic, and composite materials may be used to manufacture the receptacle, the reservoir, and spout 39.

FIG. 9 and FIG. 9B show the preferred embodiment for a plant container used with my invention. The plant container will be of circumferential configuration comprising a bottom 42 with an upstanding containment wall 43. Containment wall 43 encircles the perimeter and contiguously conjoins bottom 42. Drain hole 44 allows absorption and drainage of the nutrient solution from the plant container. A water permeable plug 45 sits on the surface of bottom 42. The preferred material for plug 45 will be phenolic open cell foam. Plug 44 will be of size and thickness capable of completely covering drain hole 48. A body 46 will be mostly filled with an absorbent material 47. Mineral wool shall be the preferred substance for absorbent material 47. A vertical distance of one inch from the surface of absorbent material 47 to the top edge of containment wall 43 shall provide space for a layer of a nonabsorbent material 48. Nonabsorbent material 48 shall be pebbles, gravel, or small rock.

Operation—Preferred Embodiment

Arrange a plurality of my hydroponic apparatus beneath a confined light source. Fill the nutrient solution reservoirs with nutrient solution. Position a multitude of prepared plant containers within the receptacles to provide the most advantageous light exposure for each plant. Activate motor 36 and pump 40 for each apparatus. Adjust cover 25 in each apparatus to allow the nutrient solution to accumulate within the rotating receptacles, but not allow for the reservoirs to completely empty. After a predetermined time turn the power for each pump 40 off. Power each pump 40 on again for further fertilization when necessary. Motor 36 continues under power during photosynthesis.

Description—Additional Embodiment

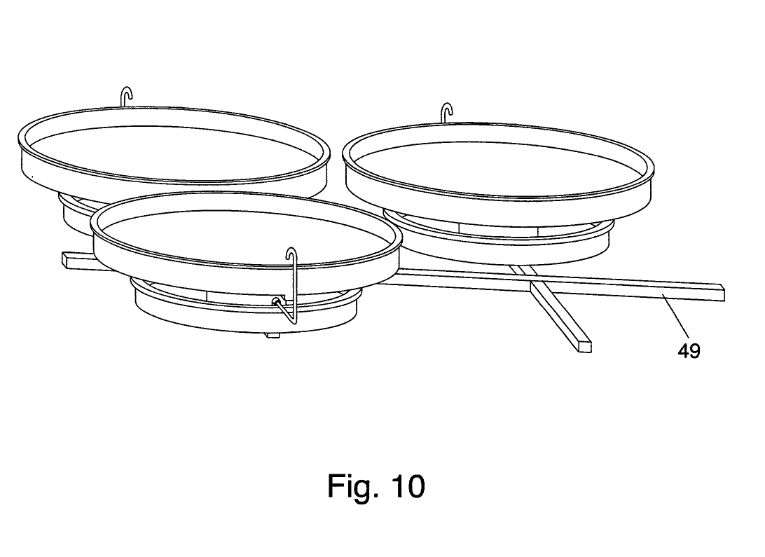

Although my hydroponic apparatus is meant to be portable and self contained, FIG. 10 shows an alternative embodiment having a plurality of rotating receptacles mounted to a frame 49.

Each receptacle may circumvolve around a vertical axis powered by a dedicated motor. Alternately, all receptacles may circumvolve via a powered rotational mechanism using a rotational energy connecting element for interfacing said receptacles with said motor. The rotational energy connecting element may include pulleys, belts, gears, chains, arbors, and all other necessary hardware.

In addition, a powered recirculative mechanism provides the capability for hydroponic fertilization. Accordingly, this mechanism may make use of individual nutrient solution reservoirs with complementing pumps for delivering nutrient solution to each receptacle via the spout. All receptacles, however, may be supplied nutrient solution via a powered recirculative mechanism using a common reservoir, a common pump, and the necessary hardware to deliver nutrient solution to each spout and return the nutrient solution to the reservoir.

Operation—Additional Embodiment

After placement beneath a light source, operation of this embodiment of my hydroponic apparatus begins by filling the reservoir(s) with nutrient solution. Position a multitude of prepared plant containers within the receptacles to provide the most advantageous light exposure for each plant. Activate the rotational drive mechanism for turning the receptacles around a vertical axis. Activate the powered recirculative mechanism for transferring nutrient solution to and from the receptacles. Adjust cover 22 in each receptacle to allow nutrient solution to accumulate within the receptacles, but not allow for the reservoir to completely empty. After a predetermined amount of time deactivate the powered recirculative mechanism. Activate the powered recirculative mechanism again for further fertilization when necessary. The rotational drive mechanism continues under power during photosynthesis.

### CONCLUSION, RAMIFICATIONS, AND SCOPE

Accordingly, the reader will see that the rotating receptacle of this invention empowers a grower with manageability tools, allowing easy replacement and repositioning of plants. The compact, self-contained design of my hydroponic apparatus enables complete maximization of vertical and horizontal growth space. In addition, the photosynthetic service area of a confined light source will easily increase by simply arranging a plurality of my hydroponic apparatus beneath the light source. As a result, a multifold increase in plant productivity will be achieved.

There are other design possibilities that could be incorporated into the subject apparatus. The bottom of the reservoir may be of a varying thickness with the thickest part being opposite the location of the pump. The submersible pump may sit in a recessed area of the reservoir lower in depth than the rest of the bottom. A combination of a bottom with a varying thickness and a recessed area for the pump would enable transferring the maximum amount of nutrient solution to the rotating receptacle. The underside surface of the reservoir bottom may have protuberances that perform as support and leveling structures. In addition, the spout may be of a swivel type enabling easy drainage of the reservoir as well as allowing exact placement of nutrient solution within the rotating receptacle.

Thus the scope of the invention should be determined by the appended claims and their legal equivalents, rather than by the examples given.

I claim:

1. A hydroponic apparatus, comprising:
(a) a receptacle for plant containment circumvolved on an axis by a rotational drive mechanism,
(b) a powered recirculative mechanism for transferring nutrient solution to and from said receptacle,
whereby hydroponic fertilization occurs within said receptacle.

2. The hydroponic apparatus according to claim 1, wherein said receptacle to be comprised of:
(a) a rigid planar bottom with a topside surface and a underside surface,
(b) an encircling, upstanding containment wall contiguously conjoined with the top surface perimeter of said bottom,
(c) a drainage orifice in said bottom,
(d) a channel formed by a quadrihedral member contiguously conjoined with the under surface of said bottom beneath said drainage orifice,
(e) a centered recessed space on the under surface of said bottom,
whereby plants rooted in removable containers are placed in said receptacles for hydroponic fertilization.

3. The hydroponic apparatus according to claim 2, wherein said removable containers comprised of:
(a) a rigid planar bottom,
(b) an encircling, upstanding containment wall contiguously conjoined with the perimeter of said bottom,
(c) a body for rooting plants,
(d) at least one drain opening,
(e) a water permeable plug for covering all drain openings,
(f) an absorbent material for rooting plants in said body,
(g) a nonabsorbent material for covering said absorbent material,
whereby preventing root growth outside of said container and algae growth within said body while promoting hydroponic fertilization.

4. The hydroponic apparatus according to claim 1, wherein said powered recirculative mechanism, in which said receptacle is included, comprising:
(a) an aqueous nutrient solution reservoir,
(b) a pump,
(c) a spout for delivering nutrient solution within said receptacle,
(d) a valve for controlling the volume of nutrient solution transferring from said receptacle to said reservoir,
whereby said receptacle remains dry until empowerment of said pump, thereafter, for a predetermined time nutrient solution recirculates between said reservoir and said receptacle.

5. The hydroponic apparatus according to claim 4, wherein said reservoir comprised of:
(b) a rigid planar bottom with a topside surface and an underside surface,
(c) an encircling, upstanding outer-containment wall contiguously conjoined with the top surface perimeter of said bottom,
(d) an aperture in the center of said bottom,
(e) an upstanding inner-containment wall, encircling said aperture, contiguously conjoined with the top surface of said bottom,
(f) an access opening in said inner containment wall,
(g) a bearing plate.

6. The hydroponic apparatus according to claim 5, wherein said bearing plate comprised of:
(1) a rigid planar member, with a topside surface and an underside surface, contiguously conjoined on the under surface with said inner-containment wall, opposed and parallel to said bottom of said reservoir,
(2) a hole in the center of said planar member.

7. The hydroponic apparatus according to claim 1, wherein said rotational drive mechanism to be comprised of:
(a) a shaft arbor locked into said recessed space of said receptacle,
(b) a turntable bearing fastened to the top surface of said bearing plate for interfacing the under surface of said receptacle,
(c) a motor mounted to the under surface of said bearing plate with its power shaft connected to said shaft arbor,
whereby empowerment of motor circumvolves said receptacle on a vertical axis.

8. A hydroponic apparatus, comprising:
(a) a receptacle for plant containment circumvolved on an axis by a rotational drive mechanism,
(b) a powered recirculative mechanism for transferring nutrient solution to and from said receptacle,
(d) a plurality of said receptacle mounted upon a frame,
whereby hydroponic fertilization occurs within said receptacles.

9. The hydroponic apparatus according to claim 8, wherein said receptacle to be comprised of:
(a) a rigid planar bottom with a topside surface and a underside surface,
(b) an upstanding containment wall encircling the perimeter of and contiguously conjoined with the top surface of said bottom,
(c) a drainage orifice in said bottom,
(d) a channel formed by a quadrihedral member contiguously conjoined with the under surface of said bottom beneath said drainage orifice,
(e) a recessed space open on the under surface of said bottom,
whereby plants rooted in removable containers placed in said receptacle absorb nutrient solution during hydroponic fertilization.

10. The hydroponic apparatus according to claim 9, wherein said removable containers to be comprised of:
(a) a rigid planar bottom,
(b) an encircling, upstanding containment wall contiguously conjoined with said bottom's perimeter,
(c) a body for rooting plants,
(d) at least one drain opening,
(e) a water permeable plug for covering all drain openings,
(f) an absorbent material for rooting plants in said body,
(g) a nonabsorbent material for covering said absorbent material,
whereby enabling root growth prevention outside of said containers, algae growth prevention within said body, and hydroponic fertilization of rooted plants.

11. The hydroponic apparatus according to claim 8, wherein said powered recirculative mechanism, in which said receptacle is included, comprising:
(a) an aqueous nutrient solution reservoir,
(b) a pump,
(c) a spout for exact placement of nutrient solution within said receptacle,
(d) a valve for controlling the volume of nutrient solution transferring from said receptacle to said reservoir,
whereby said receptacle remains dry until empowerment of said pump, thereafter, for a predetermined time nutrient solution recirculates from said reservoir into said receptacle then back to said reservoir.

12. The hydroponic apparatus according to claim 11, wherein said reservoir comprising:
(b) a rigid planar bottom with a topside surface and an underside surface,
(c) an upstanding outer-containment wall contiguously conjoined with the top surface perimeter of said bottom,
(d) an aperture in the center of said bottom,
(e) an upstanding inner-containment wall, encircling said aperture, contiguously conjoined with the top surface of said bottom,
(f) an access opening in said inner containment wall,
(g) a bearing plate.
whereby said reservoir contains the nutrient solution.

13. The hydroponic apparatus according to claim 11, wherein said bearing plate to be comprised of:
(1) a rigid planar member opposed and parallel to said bottom of said reservoir, with a topside surface and an underside surface, contiguously conjoining on its under surface with said inner-containment wall,
(2) a hole in the center of said planar member.

14. The hydroponic apparatus according to claim 8, wherein said rotational drive mechanism to be comprised of:
(a) a motor
(b) a rotational energy connecting element for coupling said receptacle and said motor,
whereby empowerment of motor rotates said receptacle around a vertical axis.

15. A hydroponic method for growing plants comprising the steps of:
(a) providing a receptacle wherein hydroponic fertilization of plants takes place,
(b) providing a recirculating means for delivery and transfer of nutrient solution to and from said receptacle,
(c) providing a rotating means for enabling said receptacle to circumvolve on a vertical axis,
(d) arranging a plurality of said receptacles beneath a confined light source for increasing the photosynthetic service area of the light source,
(e) providing a multitude of removable containers rooted with at least one plant for containment within said receptacle,
whereby plants can be removed, replaced, and repositioned within said receptacle; enabling successful plant care, increased plant manageability, the prevention of algae growth, and an abundant increase in plant productivity.

16. The hydroponic apparatus according to claim 15, wherein said removable containers comprising:
(a) a rigid planar bottom,
(b) an upstanding containment wall contiguously conjoined with the perimeter of said bottom,
(c) a body for rooting plants in water absorbent material,
(d) at least one drain opening,
(e) a water permeable plug for covering all drain openings,
(f) a nonabsorbent material for covering said absorbent material,
whereby enabling root growth prevention outside of said containers, algae growth prevention within said container, and hydroponic fertilization by movement of nutrient solution into said container via said drain opening through said water-permeable plug into said absorbent material.
